(19) United States
(12) Patent Application Publication
(10) Pub. No.: US 2013/0115919 A1
(43) Pub. Date: May 9, 2013

(54) METHOD, ROUTING AGENT NETWORK ELEMENT, AND SYSTEM FOR IMPLEMETING ADDRESSING AMONG DIFFERENT NETWORKS

(71) Applicant: HUAWEI TECHNOLOGIES CO., LTD., Shenzhen (CN)

(72) Inventors: Xiaoru Xu, Shenzhen (CN); Wenfu Wu, Shanghai (CN)

(73) Assignee: HUAWEI TECHNOLOGIES CO., LTD., Shenzhen (CN)

(21) Appl. No.: 13/726,844

(22) Filed: Dec. 26, 2012

Related U.S. Application Data
(63) Continuation of application No. PCT/CN2010/079435, filed on Dec. 3, 2010.

(51) Int. Cl. H04W 12/06

(52) U.S. Cl. CPC H04W 12/06
USPC 455/411

(57) ABSTRACT

Embodiments of the present invention disclose a method, a routing agent network element, and a system relating to the communication technology field for implementing addressing among different networks, improving the security of an addressing process among different networks. The method for implementing addressing among different networks includes: receiving a Diameter request message carrying a local IP address of a terminal and/or a network identity of a second network from a policy control node of a first network; selecting a routing agent network element of the second network according to the local IP address of the terminal and/or the network identity of the second network; returning network element information about the routing agent network element of the second network to the policy control node of the first network; or obtaining node information about the policy control node of the second network from the routing agent network element of the second network.

### CROSS-REFERENCE TO RELATED APPLICATIONS

This application is a continuation of International Application No. PCT/CN2010/079435, filed on Dec. 3, 2010, which is hereby incorporated by reference in its entirety.

### FIELD OF THE INVENTION

The present invention relates to the field of communication technologies, and in particular to a method, a routing agent network element, and a system for implementing addressing among different networks.

### BACKGROUND OF THE INVENTION

A terminal supporting the 3GPP (3rd Generation Partnership Project, 3rd Generation Partnership Project) protocol may generally be referred to as a 3GPP UE (User Equipment, user equipment). When a 3GPP UE accesses an EPS (Evolved 3GPP Packet Switched domain, evolved mobile packet switched domain network) network through a BBF (Broadband Forum, broadband forum, generally referred to as a fixed network) network, data may be routed back to an EPC (Evolved Packet Core, evolved packet core network) network. Therefore, interaction operations of policy control and QoS (Quality of Service, quality of service parameter) rules need to be performed between the 3GPP network and the BBF network. The interaction operations are generally completed between a policy control network element BPCF (BBF Policy Control Function) of the BBF network and a policy control network element PCRF (Policy and Charging Rules Function, policy and charging rules function) of the 3GPP network.

However, the 3GPP network may include multiple Diameter domains, and each

Diameter domain may include multiple PCRFs. Therefore, if a BPCF of the BBF network directly addresses a PCRF of the 3GPP network, each BPCF needs to be performed with many static node configurations or route configurations of certain intermediate nodes, enabling the BPCF to successfully address the PCRF. In this manner, the local configurations on the BPCF are excessive, which affects the network topology complexity, maintenance complexity, and efficiency of the BPCF in addressing the PCRF. On the contrary, if a PCRF addresses a BPCF, the same problem exists.

To solve the preceding problem, the existing BBF network and 3GPP network introduce a DRA (Diameter Routing Agent, Diameter routing agent) network element, enabling the BPCF to address the PCRF through the DRA network element (BBF DRA) of the BBF network or to address the PCRF through the DRA network element (3GPP DRA) of the 3GPP network.

However, the preceding solution also has a defect, that is, the Diameter domain of the BBF network cannot be isolated from the Diameter domain of the 3GPP network. To be specific, for the Diameter domain of the BBF network and the Diameter domain of the 3GPP network, logical isolation cannot be implemented between a policy control network element of a network and another network. Therefore, certain latent problems of network security exist.

### SUMMARY OF THE INVENTION

Embodiments of the present invention provide a method, a routing agent network element, and a system for implementing addressing among different networks, improving security of an addressing process among different networks.

To meet the preceding purpose, embodiments of the present invention use the following technical solutions:

A method for implementing addressing among different networks includes:

receiving a Diameter request message carrying a local Internet Protocol (IP) address of a terminal and/or a network identity of a second network from a policy control node of a first network;

selecting a routing agent network element of the second network according to the local IP address of the terminal or the network identity of the second network; and

returning network element information about the routing agent network element of the second network to the policy control node of the first network; or obtaining node information about the policy control node of the second network from the routing agent network element of the second network.

A routing agent network element, where the routing agent network element is located on a first network, and the routing agent network element includes: a receiving unit, configured to receive a Diameter request message carrying a local IP address of a terminal and/or a network identity of a second network from a policy control node of the first network;

a selecting unit, configured to select a routing agent network element of the second network according to the local IP address of the terminal or the network identity of the second network;

a first sending unit, configured to return network element information about the routing agent network element of the second network to the policy control node of the first network; and/or

an obtaining unit, configured to obtain node information about the policy control node of the second network from the routing agent network element of the second network.

A communication system includes a policy control node and a routing agent network element of a first network, where:

the policy control node of the first network is configured to send a Diameter request message to the routing agent network element of the first network, where the Diameter request message carries a local IP address of a terminal and/or a network identity of a second network;

the routing agent network element of the first network is configured to select a routing agent network element of the second network according to the received local IP address of the terminal or the network identity of the second network and return network element information about the routing agent network element of the second network to the policy control node of the first network; or

the routing agent network element of the first network is configured to select a routing agent network element of the second network according to the received local IP address of the terminal or the network identity of the second network and obtain node information about the policy control node of the second network from the routing agent network element of the second network.

According to the technical solutions provided in the embodiments of the present invention, addressing between two networks is completed through addressing between their own corresponding routing agent network elements, thereby implementing domain isolation between two networks, and improving security of an addressing process among different networks.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from these accompanying drawings without creative efforts.

FIG. 1 is a flow chart of a method for implementing addressing among different networks according to Embodiment 1 of the present invention;

FIG. 2 is a schematic structural diagram of a routing agent network element according to Embodiment 1 of the present invention;

FIG. 3 is a signaling flow chart of a process for implementing addressing among different networks according to Embodiment 2 of the present invention;

FIG. 4 is a signaling flow chart of a process for implementing addressing among different networks according to Embodiment 3 of the present invention;

FIG. 5 is a signaling flow chart of a process for implementing addressing among different networks according to Embodiment 4 of the present invention;

FIG. 6 is a signaling flow chart of a process for implementing addressing among different networks according to Embodiment 5 of the present invention;

FIG. 7 is a signaling flow chart of a process for implementing addressing among different networks according to Embodiment 6 of the present invention;

FIG. 8 is a signaling flow chart of a process for implementing addressing among different networks according to Embodiment 7 of the present invention;

FIG. 9 is a schematic structural diagram of a routing agent network element according to Embodiment 8 of the present invention;

FIG. 10 is a schematic structural diagram of an obtaining unit in FIG. 9; and

FIG. 11 is a schematic structural diagram of a communication system according to Embodiment 9 of the present invention.

### DETAILED DESCRIPTION OF THE EMBODIMENTS

The following clearly and completely describes the technical solutions according to the embodiments of the present invention with reference to the accompanying drawings in the embodiments of the present invention. Apparently, the embodiments in the following description are merely a part rather than all of the embodiments of the present invention. All other embodiments obtained by persons of ordinary skill in the art based on the embodiments of the present invention without creative efforts shall fall within the protection scope of the present invention.

A method, a routing agent network element, and a system provided in the embodiments of the present invention for implementing addressing among different networks are described in further detail below with reference to the accompanying drawings.

### Embodiment 1

For ease of description in this embodiment, a routing agent network element of a first network is referred to as a first routing agent network element, and a policy control node of the first network is referred to as a first policy control node; a routing agent network element of a second network is referred to as a second routing agent network element, and a policy control node of the second network is referred to as a second policy control node.

The first network and the second network may be a BBF network and a 3GPP network respectively, the first network and the second network may also be a 3GPP network and a BBF network respectively, and the first network and the second network may also be a visited network and a home network of a mobile network respectively; certainly, the specific implementation of the first network and the second network is not limited to the preceding three conditions, and may also be different PLMN (Public Land Mobile-communication Network, public land mobile-communication network) networks of other 3GPP networks.

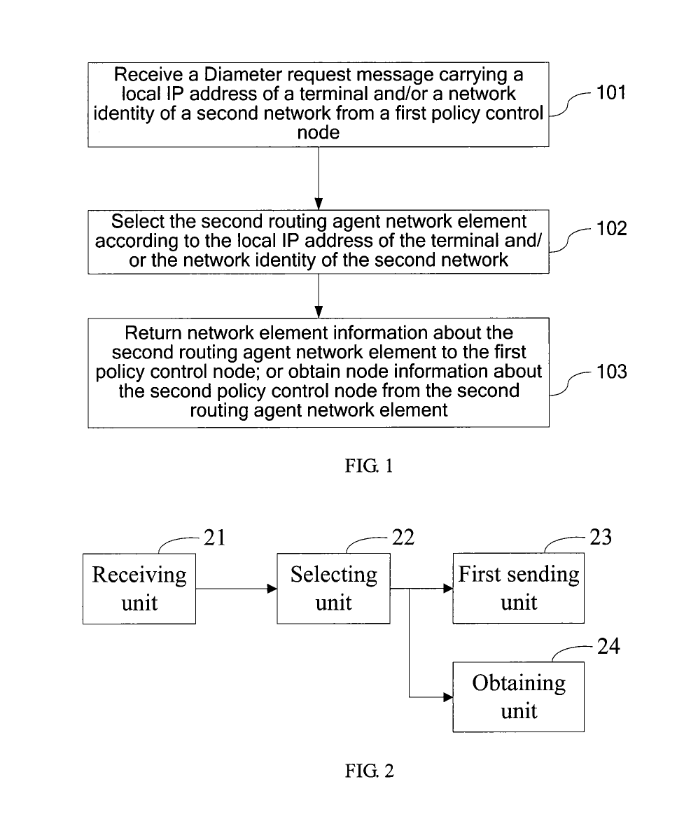

As shown in FIG. 1, a method provided in this embodiment for implementing addressing among different networks includes:

101. Receive a Diameter request message carrying a local IP (Internet Protocol, Internet Protocol) address of a terminal and/or a network identity of a second network from a first policy control node.

The local IP address of the terminal is assigned to a 3GPP UE by a BNG (Broadband Network Gateway, broadband network gateway) or BRAS (Broadband Remote Access Server, broadband remote access server) of the BBF network, and is sent to the first policy control node through a session establishment request message.

The network identity of the second network of which the BNG or BRAS may be informed by a UE during the authentication process, or is returned to the BNG or BRAS by 3GPP AAA (Authentication, Authorization & Accounting, authentication, authorization & accounting) or an HSS (Home Subscriber Server, home subscriber server) through a authentication response message during the authentication process, and then is sent to the first policy control node by the BNG or BRAS through a session establishment request message.

If the second network is a 3GPP network, the network identity of the second network is a mobile network identity, which may be PLMN information about a mobile network; if the second network is a BBF network, the network identity of the second network is a BBF network identity.

The Diameter request message may be a gateway control session establishment request, a gateway control QoS rule provisioning request message, or an Rx/S9 Diameter establishment request.

Moreover, the Diameter request message may also carry one or multiple items of a UE identity mapping the terminal on the second network, a UE NAI (Network Access Identifier, network access identifier of a UE on the second network) on the second network, a UE identity on the first network, and a UE NAI, EPS IP address, and APN (Access Point Name, access point name) on the first network. The UE NAI on the second network may include a network identity of the second network, and the UE NAI on the first network may include a network identity of the first network. An EPS IP can uniquely identify a PDN (Packet Data Network, packet data network) connection of a UE on a 3GPP network.

102. Select the second routing agent network element according to the local IP address of the terminal and/or the network identity of the second network.

Specifically, the second routing agent network element may be obtained from the static/dynamic configuration of the device itself or DNS (Domain Name System, domain name system) server according to the configuration relationship between the local IP address and/or the network identity of the second network and the second routing agent network element.

The configuration relationship may be a mapping between the local IP address and/or the network identity of the second network and the address of the second routing agent network element; the expression form of the mapping may be but is not limited to a mapping table and the like stored on the device itself or DNS. In this manner, as long as the local IP address and/or the network identity of the second network are obtained, the second routing agent network element mapping the local IP address and/or the network identity of the second network may be obtained by querying the mapping table.

103. Return network element information about the second routing agent network element to the first policy control node; or obtain node information about the second policy control node from the second routing agent network element.

Specifically, when the second routing agent network element provides the proxy (Proxy) function, return network element information about the second routing agent network element to the first policy control node, and then the first policy control node may send information to the second routing agent network element according to the network element information about the second routing agent network element, and the second routing agent network element forwards a received message to the second policy control node;

when the second routing agent network element provides the redirection (Redirect) function, obtain node information about the second policy control node from the second routing agent network element, and then the routing agent network element of the first network may send a message to the second policy control node according to the node information about the second policy control node, or inform the first policy control node of the obtained node information about the second policy control node, and the first policy control node directly sends a message to the second policy control node according to the node information about the second policy control node.

The steps of the preceding method may be performed by a routing agent network element (DRA) of the first network.

Corresponding to the preceding method for implementing addressing among different networks, this embodiment also provides a routing agent network element for implementing the preceding method, and the routing agent network element is located on the first network.

As shown in FIG. 2, the routing agent network element includes:

a receiving unit 21, configured to receive a Diameter request message carrying a local IP address of a terminal and/or a network identity of a second network from a policy control node of a first network;

a selecting unit 22, configured to select a routing agent network element of the second network according to the local IP address of the terminal and/or the network identity of the second network;

a first sending unit 23, configured to return network element information about the routing agent network element of the second network to the policy control node of the first network; and/or

an obtaining unit 24, configured to obtain node information about the policy control node of the second network from the routing agent network element of the second network.

According to the method and routing agent network element for implementing addressing among different networks provided in this embodiment, addressing between two networks is completed through addressing between routing agent network elements of the first network and the second network, thereby implementing domain isolation between two networks, and improving security of an addressing process among different networks.

The following embodiments further describe the method for implementing addressing among different networks according to this embodiment based on instances in different scenarios.

The method and routing agent network element for implementing addressing among different networks provided in this embodiment implement addressing between two different networks based on the selection between a routing agent network element of a first network and a routing agent network element of a second network, and further for different functional attributes of routing agent network elements, the routing agent network element of the first network may return network element information about the selected routing agent network element of the second network to a policy control node of the first network, facilitating the policy control node of the first network to address the routing agent network element node of the second network according to the network element information, and then complete addressing from the policy control node of the first network to the policy control node of the second network;

or the routing agent network element of the first network may obtain node information about the policy control node of the second network from the routing agent network element of the second network, facilitating the routing control node of the first network to address the policy control node of the second network according to the node information, or instruct the policy control node of the first network to address the policy control node of the second network according to the node information.

### Embodiment 2

This embodiment provides a method for addressing between a BBF network and a 3GPP network, implementing a correct addressing process between a policy control network element BPCF of the BBF network and a policy control network element PCRF of a mobile network (for example, a GERAN, UTRAN, or E-UTRAN network of a 3GPP network) in an FMC (Fixed Mobile Convergence, fixed mobile convergence) scenario.

The BBF network is a first network, and the 3GPP network is a second network. The BBF network in this embodiment supports 3GPP-based authentication; moreover, a Diameter routing agent network element BBF DRA of the BBF network provides the redirection (Redirect) function, and a Diameter routing agent network element 3GPP DRA of the 3GPP network provides the redirection or proxy (Proxy) function.

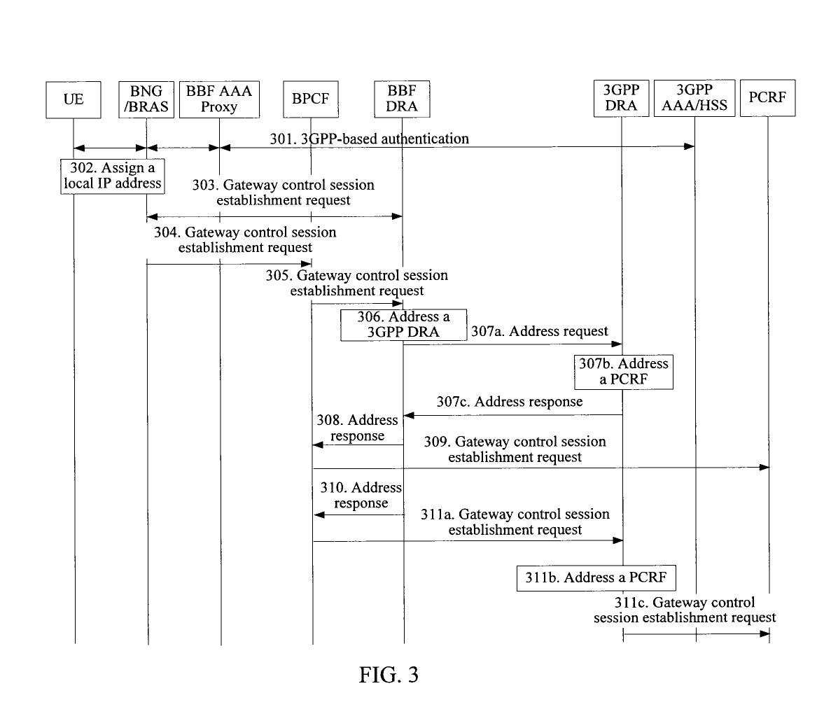

As shown in FIG. 3, a method provided in this embodiment for implementing addressing among different networks includes the following steps:

301. Perform a 3GPP-based authentication process.

Specifically, a UE initiates a BBF network authentication request carrying a 3GPP UE NAI, where the 3GPP UE NAI includes a 3GPP UE identity and may further include a mobile network identity; the 3GPP UE identity may be an IMSI (International Mobile Subscriber Identification Number, international mobile subscriber identification number), and the mobile network identity may be PLMN information about a mobile network.

In the 3GPP authentication process, a BNG or BRAS of the BBF network obtains the 3GPP UE NAI.

If the 3GPP UE NAI does not include a mobile network identity, a 3GPP AAA or an HSS returns a mobile network identity to the BNG or BRAS through an authentication response message in the 3GPP authentication process.

When initiating an authentication request to the AAA or HSS, a 3GPP UE carries related information about a network access point through which the authentication request passes, including a mobile network identity.

302. The BNG or BRAS assigns a Local IP address (local IP address, or referred to as a local IP address assigned by a fixed network) to the 3GPP UE.

303. The BNG or BRAS sends a session establishment request message of the BBF network to the BBF DRA, where the request message carries a Local IP address or a 3GPP UE NAI; and the BBF DRA selects a BPCF according to the Local IP address or 3GPP UE NAI and returns BPCF information to the BNG or BRAS.

The BPCF information may be a Diameter Identity (Diameter identity) or an IP address of the BPCF.

304. The BNG or BRAS sends the session establishment request message of the BBF network to the selected BPCF according to the BPCF information; where the request message includes a Local IP address or a 3GPP UE NAI.

305. If the BPCF detects that the message includes a 3GPP UE identity, or a mobile network identity, or a 3GPP UE NAI, the BPCF sends a gateway control session establishment request message for interaction between the BBF network and the 3GPP network to the BBF DRA, where the message includes a Local IP address and a mobile network identity or a 3GPP UE NAI, and may also include a 3GPP UE identity.

306. The BBF DRA selects a DRA, namely a 3GPP DAR, of the mobile network according to the mobile network identity carried in the session establishment request message or the mobile network identity carried in the 3GPP UE NAI, and detects the functional attribute of the selected 3GPP DRA.

Specifically, the BBF DRA may select a 3GPP DRA from the static/dynamic configuration of the device itself or DNS server according to the configuration relationship between the mobile network identity and the 3GPP DRA.

The process of detecting the functional attribute of the selected 3GPP DRA may be that the BBF DRA actively sends a detection message to the 3GPP DRA to obtain the functional attribute of the other party and inform the other party of its own functional attribute.

The functional attribute of the 3GPP DRA may be the redirection function or the proxy function. If the 3GPP DRA provides the redirection function, perform steps 307, 308, and 309; if the 3GPP DRA provides the proxy function, perform steps 310 and 311.

307. The BBF DRA obtains information about a PCRF of the 3GPP network from the selected 3GPP DRA.

Specifically, step 307 may be implemented through the following procedures:

307a. The BBF DRA sends an address request message (Address Request) to the selected 3GPP DRA, where the address request message includes a 3GPP UE NAI or Local IP address.

307b. The 3GPP DRA selects a PCRF according to the 3GPP UE NAI.

Specifically, the 3GPP DRA may select a PCRF mapping the 3GPP UE NAI based on parameters such as UE subscription information and a network segment to which the user belongs.

307c. The 3GPP DRA returns PCRF information to the BBF DRA through an address response message. The PCRF information may be a Diameter Identity or an IP address of the selected PCRF.

308. When the 3GPP DRA provides the redirection function, the BBF DRA sends the PCRF information to the BPCF.

309. The BPCF sends a gateway control session establishment request for interaction between the BBF network and the 3GPP network to the selected PCRF according to the PCRF information.

310. When the 3GPP DRA provides the proxy function, the BBF DRA returns 3GPP DRA information to the BPCF.

The 3GPP DRA information may be a Diameter Identity or an IP address of the 3GPP DRA.

311. The BPCF initiates an addressing process to the PCRF through the 3GPP DRA.

Specifically, step 311 may be implemented through the following procedures:

311a. The BPCF sends a gateway control session establishment request message for interaction between the BBF network and the 3GPP network according to the received 3GPP DRA information; where the message includes a Local IP address and a 3GPP UE NAI;

311b. After receiving the gateway control session establishment request, the 3GPP DRA selects a PCRF according to the carried 3GPP UE NAI.

Specifically, the 3GPP DRA may select a PCRF mapping the 3GPP UE NAI based on parameters such as UE subscription information and a network segment to which the user belongs.

311c. The 3GPP DRA forwards the gateway control session establishment request for interaction between the BBF network and the 3GPP network to the selected PCRF.

In this embodiment, addressing from the BBF network to the 3GPP network is completed based on the Diameter routing agent network elements of the BBF network and 3GPP network; in this manner, domain isolation may be implemented between the BBF network and the 3GPP network, and thereby the security of an addressing process among different networks is improved.

### Embodiment 3

A communication scenario provided in this embodiment is similar to that provided in Embodiment 2; in this embodiment, the difference is that a Diameter routing agent network element BBF DRA of a BBF network provides the proxy function, and a Diameter routing agent network element 3GPP DRA of a 3GPP network provides the redirection or proxy function.

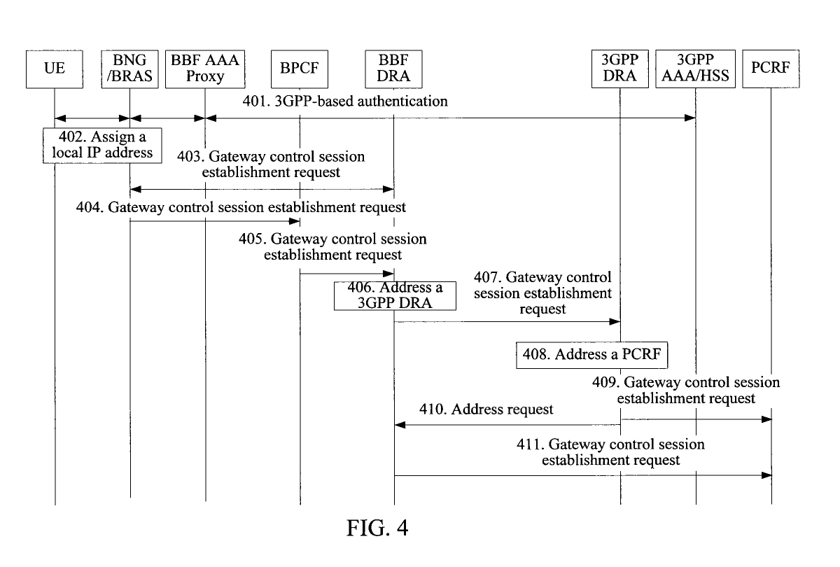

As shown in FIG. 4, a method provided in this embodiment for implementing addressing among different networks includes the following steps:

401. Perform a 3GPP-based authentication process.

Specifically, a UE initiates a BBF network authentication request carrying a 3GPP UE NAI, where the 3GPP UE NAI includes a 3GPP UE identity and may further include a mobile network identity.

In the 3GPP authentication process, a BNG or BRAS of the BBF network obtains the 3GPP UE NAI.

If the 3GPP UE NAI does not include a mobile network identity, a 3GPP AAA or an HSS returns a mobile network identity to the BNG or BRAS through an authentication response message in the 3GPP authentication process.

When initiating an authentication request to the AAA or HSS, a 3GPP UE carries related information about a network access point through which the authentication request passes, including a mobile network identity.

402. The BNG or BRAS assigns a Local IP address to the 3GPP UE.

403. The BNG or BRAS sends a session establishment request message of the BBF network to the BBF DRA, where the message carries a Local IP address or a 3GPP UE NAI; and the BBF DRA selects a BPCF according to the Local IP address or 3GPP UE NAI and returns BPCF information to the BNG or BRAS.

The BPCF information may be a Diameter Identity or an IP address of the BPCF.

404. The BNG or BRAS sends the session establishment request message of the BBF network to the selected BPCF according to the BPCF information; where the message includes a Local IP address or a 3GPP UE NAI.

405. If the BPCF detects that the message includes a 3GPP UE identity, or a mobile network identity, or a 3GPP UE NAI, the BPCF sends a gateway control session establishment request message for interaction between the BBF network and the 3GPP network to the BBF DRA, where the message includes a Local IP address and a mobile network identity or a 3GPP UE NAI, and may also include a 3GPP UE identity.

406. The BBF DRA selects a 3GPP DAR of the mobile network according to the mobile network identity carried in the session establishment request message or the mobile network identity carried in the 3GPP UE NAI.

Specifically, the BBF DRA may select a 3GPP DRA from the static/dynamic configuration of the device itself or DNS server according to the configuration relationship between the mobile network identity and the 3GPP DRA.

407. Because the BBF DRA in this embodiment provides the proxy function, the BBF DRA forwards the received gateway control session establishment request to the selected 3GPP

DRA; where the gateway control session establishment request carries a 3GPP UE NAI.

408. The 3GPP DRA selects a PCRF of the 3GPP network according to the 3GPP UE NAI.

Specifically, the 3GPP DRA may select a PCRF mapping the 3GPP UE NAI based on parameters such as UE subscription information and a network segment to which the user belongs.

If the 3GPP DRA provides the proxy function, perform step 409; if the 3GPP DRA provides the redirection function, perform steps 410 and 411.

409. The 3GPP DRA forwards the received gateway control session establishment request to the selected PCRF.

410. The 3GPP DRA returns PCRF information to the BBF DRA through an address response message. The PCRF information may be a Diameter Identity or an IP address of the PCRF.

411. The BBF DRA forwards the gateway control session establishment request for interaction between the BBF network and the 3GPP network to the selected PCRF according to the PCRF information.

In this embodiment, addressing from the BBF network to the 3GPP network is completed based on the Diameter routing agent network elements of the BBF network and 3GPP network; in this manner, domain isolation may be implemented between the BBF network and the 3GPP network, and thereby the security of an addressing process among different networks is improved.

### Embodiment 4

This embodiment provides a method for addressing between a BBF network and a 3GPP network, implementing a correct addressing process between a policy control network element BPCF of the BBF network and a policy control network element PCRF of a mobile network in an FMC scenario.

The 3GPP network is a first network, and the BBF network is a second network. The BBF network in this embodiment does not support 3GPP-based authentication; moreover, a Diameter routing agent network element 3GPP DRA of the 3GPP network provides the redirection function, and a Diameter routing agent network element BBF DRA of the BBF network provides the redirection or proxy function.

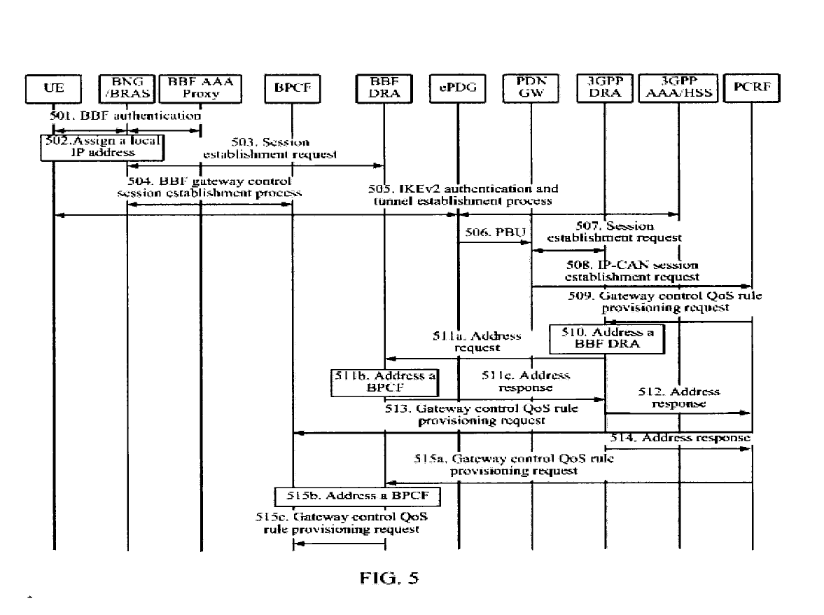

As shown in FIG. 5, a method provided in this embodiment for implementing addressing among different networks includes the following steps:

501. Perform an authentication process of the BBF network.

A BNG or BRAS obtains a BBF UE identity or a BBF UE NAI; where the BBF UE NAI includes a BBF UE identity and a BBF network identity. The BBF UE identity may be a user identity (for example, a user name) of a 3GPP UE on the BBF network.

502. The BNG or BRAS assigns a Local IP address to the 3GPP UE.

503. The BNG or BRAS sends a session establishment request message of the BBF network to the BBF DRA, where the message carries a Local IP address, or a BBF UE identity, or a BBF UE NAI; and the BBF DRA selects a BPCF according to the Local IP address, BBF UE identity, or BBF UE NAI and returns BPCF information to the BNG or BRAS.

The BPCF information may be a Diameter Identity (Diameter identity) or an IP address of the BPCF.

504. The BNG or BRAS sends the session establishment request message of the BBF network to the selected BPCF according to the BPCF information; where the message includes a Local IP address, or a BBF UE identity, or a BBF UE NAI.

505. Perform IKEv2 (Internet Key Exchange, Internet Key Exchange Protocol version 2) authentication and tunnel establishment processes.

In the authentication and tunnel establishment processes, a message initiated by a UE carries a BBF network identity, or a BBF UE identity, or a Local IP address, or a BBF UE NAI, or a 3GPP UE identity, or a 3GPP UE NAI, and 3GPP access authentication and PDN (Packet Date Network, packet data network) network access authentication are performed;

An ePDG (Evolved Packet Data Gateway, evolved packet data gateway) obtains a BBF network identity, or a BBF UE identity, or a BBF UE NAI, or a Local IP address.

Moreover, because a mapping between a Local IP address segment and a BBF network identity may be configured and maintained in the ePDG the ePDG may also obtain a BBF network identity according to the Local IP address and configuration information.

506. The ePDG initiates a proxy binding message (Proxy Binding Update, PBU) to a PDN GW (packet data network gateway), where the message includes one or multiple items of a 3GPP UE identity, a 3GPP UE NAI, an EPS IP, an APN (Access Point Name, access point name), a BBF network identity, a BBF UE identity, a BBF UE NAI, and a Local IP address.

The EPS IP is an IP address assigned by the 3GPP network to the 3GPP UE.

507. The PDN GW sends a session establishment request to the 3GPP DRA, where the message includes one or multiple items of a 3GPP UE identity, a 3GPP UE NAI, an EPS IP, and an APN;

The 3GPP DRA selects a PCRF according to the 3GPP UE identity, 3GPP UE NAI, EPS IP, or APN, and returns information about the selected PCRF to the PDN GW.

508. The PDN GW sends an IP-CAN session establishment request message to the obtained PCRF, where the IP-CAN session establishment request message includes one or multiple items of a 3GPP UE identity, a 3GPP UE NAI, an EPS IP, an APN, a BBF network identity, a BBF UE identity, a BBF UE NAI, and a Local IP address.

509. If the PCRF detects that the IP-CAN session carries a BBF network identity, or a BBF UE NAI, or a Local IP address, the PCRF sends a gateway control QoS rule provisioning request message to the 3GPP DRA;

The message includes a Local IP address and/or a BBF network identity, and may also include one or multiple items of a 3GPP UE identity, a 3GPP UE NAI, an EPS IP, an APN, a BBF UE identity, and a BBF UE NAI.

510. The 3GPP DRA selects a DRA, namely a BBF DRA, of the BBF network according to the BBF network identity, BBF network identity included in the BBF UE NAI, or Local IP address, and detects the functional attribute of the selected BBF DRA.

Specifically, the 3GPP DRA may select a BBF DRA from the static/dynamic configuration of the device itself or DNS server according to the configuration relationship between the BBF network identity or Local IP address and the BBF DRA.

The process of detecting the functional attribute of the selected BBF DRA may be that the 3GPP DRA actively sends a detection message to the BBF DRA to obtain the functional attribute of the other party and inform the other party of its own functional attribute.

The functional attribute of the BBF DRA may be the redirection function or the proxy function. If the BBF DRA provides the redirection function, perform steps 511, 512, and 513; if the

BBF DRA provides the proxy function, perform steps 514 and 515.

511. When the BBF DRA provides the redirection function, the BBF DRA obtains information about a PCRF of the 3GPP network from the selected 3GPP DRA.

Specifically, step 511 may be implemented through the following procedures:

511a. The 3GPP DRA sends an address request message to the BBF DRA, where the message includes a BBF UE identity, or a BBF UE NAI, or a Local IP address;

511b. The BBF DRA selects a BPCF according to the BBF UE identity, BBF UE NAI, or Local IP address; alternatively, the BBF DRA finds a BPCF that has established a session according to the BBF UE identity, BBF UE NAI, or Local IP address;

511c. The BBF DRA returns BPCF information to the 3GPP DRA through an address response message. The BPCF information may be a Diameter Identity or an IP address of the BPCF.

512. The 3GPP DRA sends the BPCF information to the PCRF.

513. The PCRF sends a gateway control QoS rule provisioning request message to the selected BPCF according to the BPCF information.

514. When the BBF DRA provides the proxy function, the 3GPP DRA returns BBF DRA information to the PCRF.

The BBF DRA information may be a Diameter Identity or an IP address of the BBF DRA.

515. The PCRF initiates an addressing process to the BPCF through the BBF DRA.

Specifically, step 515 may be implemented through the following procedures:

515a. The PCRF sends a gateway control QoS rule provisioning request message to the BBF DRA according to the received BBF DRA; where the message carries a BBF UE identity, or a BBF UE NAI, or a Local IP address;

515b. After receiving the gateway control QoS rule provisioning request message, the

BBF DRA selects a BPCF according to the BBF UE identity, BBF UE NAI, or Local IP address; alternatively, the BBF DRA finds a BPCF that has established a session according to the BBF UE identity, BBF UE NAI, or Local IP address;

515c. The BBF DRA forwards the gateway control QoS rule provisioning request message to the selected BPCF.

In this embodiment, addressing from the 3GPP network to the BBF network is completed based on the Diameter routing agent network elements of the 3GPP network and BBF network; in this manner, domain isolation may be implemented between the BBF network and the 3GPP network, and thereby the security of an addressing process among different networks is improved.

### Embodiment 5

A communication scenario provided in this embodiment is similar to that provided in Embodiment 4; in this embodiment, the difference is that a Diameter routing agent network element 3GPP DRA of a 3GPP network provides the proxy function, and a Diameter routing agent network element BBF DRA of a BBF network provides the redirection or proxy function.

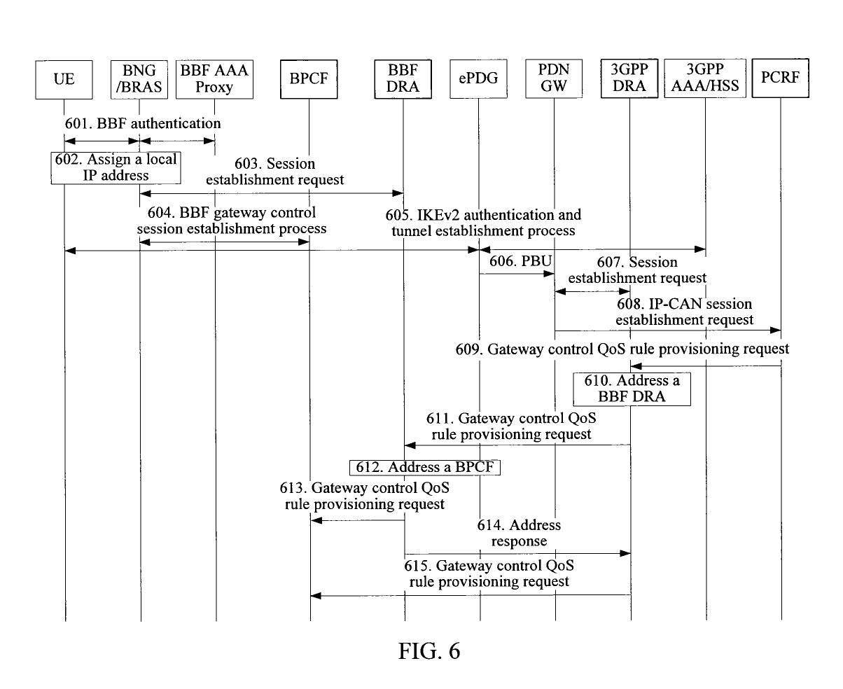

As shown in FIG. 6, a method provided in this embodiment for implementing addressing among different networks includes the following steps:

601. Perform an authentication process of the BBF network.

A BNG or BRAS obtains a BBF UE identity or a BBF UE NAI; where the BBF UE NAI includes a BBF UE identity and a BBF network identity. The BBF UE identity may be a user identity (for example, a user name) of a 3GPP UE on the BBF network.

602. The BNG or BRAS assigns a Local IP address to the 3GPP UE.

603. The BNG or BRAS sends a session establishment request message of the BBF network to the BBF DRA, where the message carries a Local IP address, or a BBF UE identity, or a BBF UE NAI; and the BBF DRA selects a BPCF according to the Local IP address, BBF UE identity, or BBF UE NAI and returns BPCF information to the BNG or BRAS.

The BPCF information may be a Diameter Identity or an IP address of the BPCF.

604. The BNG or BRAS sends the session establishment request message of the BBF network to the selected BPCF according to the BPCF information; where the message includes a Local IP address, or a BBF UE identity, or a BBF UE NAI.

605. Perform IKEv2 authentication and tunnel establishment processes.

In the authentication and tunnel establishment processes, a message initiated by a UE carries a BBF network identity, or a BBF UE identity, or a Local IP address, or a BBF UE NAI, or a 3GPP UE identity, or a 3GPP UE NAI, and 3GPP access authentication and PDN network access authentication are performed;

An ePDG obtains a BBF network identity, or a BBF UE identity, or a BBF UE NAI, or a Local IP address.

Moreover, the ePDG may also obtain a BBF network identity according to the Local IP address and configuration information.

606. The ePDG initiates a proxy binding message (PBU) to a PDN GW, where the proxy binding message includes one or multiple items of a 3GPP UE identity, a 3GPP UE NAI, an EPS IP, an APN, a BBF network identity, a BBF UE identity, a BBF UE NAI, and a Local IP address.

The EPS IP is an IP address assigned by the 3GPP network to the 3GPP UE.

607. The PDN GW sends a session establishment request to the 3GPP DRA, where the message includes one or multiple items of a 3GPP UE identity, a 3GPP UE NAI, an EPS IP, and an APN;

The 3GPP DRA selects a PCRF according to the 3GPP UE identity, 3GPP UE NAI, EPS IP, or APN, and returns information about the selected PCRF to the PDN GW.

608. The PDN GW sends a session establishment request message to the obtained PCRF, where the IP-CAN session establishment request message includes one or multiple items of a 3GPP UE identity, a 3GPP UE NAI, an EPS IP, an APN, a BBF network identity, a BBF UE identity, a BBF UE NAI, and a Local IP address.

609. If the PCRF detects that the IP-CAN session carries a BBF network identity, or a BBF UE NAI, or a Local IP address, the PCRF sends a gateway control QoS rule provisioning request message to the 3GPP DRA;

The message includes a Local IP address and/or a BBF network identity, and may also include one or multiple items of a 3GPP UE identity, a 3GPP UE NAI, an EPS IP, an APN, a BBF UE identity, and a BBF UE NAI.

610. The 3GPP DRA selects a DRA, namely a BBF DRA, of the BBF network according to the BBF network identity, BBF network identity included in the BBF UE NAI, or Local IP address.

Specifically, the 3GPP DRA may select a BBF DRA from the static/dynamic configuration of the device itself or DNS server according to the configuration relationship between the BBF network identity or Local IP address and the BBF DRA.

611. Because the 3GPP DRA in this embodiment provides the proxy function, the 3GPP DRA forwards the received gateway control QoS rule provisioning request message to the selected BBF DRA; where the gateway control QoS rule provisioning request message carries a BBF UE identity, or a BBF UE NAI, or a Local IP address.

612. The BBF DRA selects a BPCF of the BBF network according to the BBF UE identity, BBF UE NAI, or Local IP address.

If the BBF DRA provides the proxy function, perform step 613; if the BBF DRA provides the redirection function, perform steps 614 and 615.

613. The BBF DRA forwards the received gateway control QoS rule provisioning request message to the selected BPCF.

614. The BBF DRA returns BPCF information to the 3GPP DRA through an address response message. The BPCF information may be a Diameter Identity or an IP address of the BPCF.

615. The 3GPP DRA forwards the gateway control QoS rule provisioning request message to the selected BPCF according to the BPCF information.

In this embodiment, addressing from the 3GPP network to the BBF network is completed based on the Diameter routing agent network elements of the 3GPP network and BBF network; in this manner, domain isolation may be implemented between the BBF network and the 3GPP network, and thereby the security of an addressing process among different networks is improved.

### Embodiment 6

This embodiment provides a method for addressing between two different 3GPP networks, implementing a correct addressing process from a visited location to a home location in a roaming scenario.

The 3GPP network in the visited location is a first network, and the 3GPP network in the home location is a second network. In this embodiment, the DRA (3GPP V-DRA) of the 3GPP network in the visited location provides the redirection function, and the DRA (3GPP H-DRA) of the 3GPP network in the home location provides the redirection or proxy function.

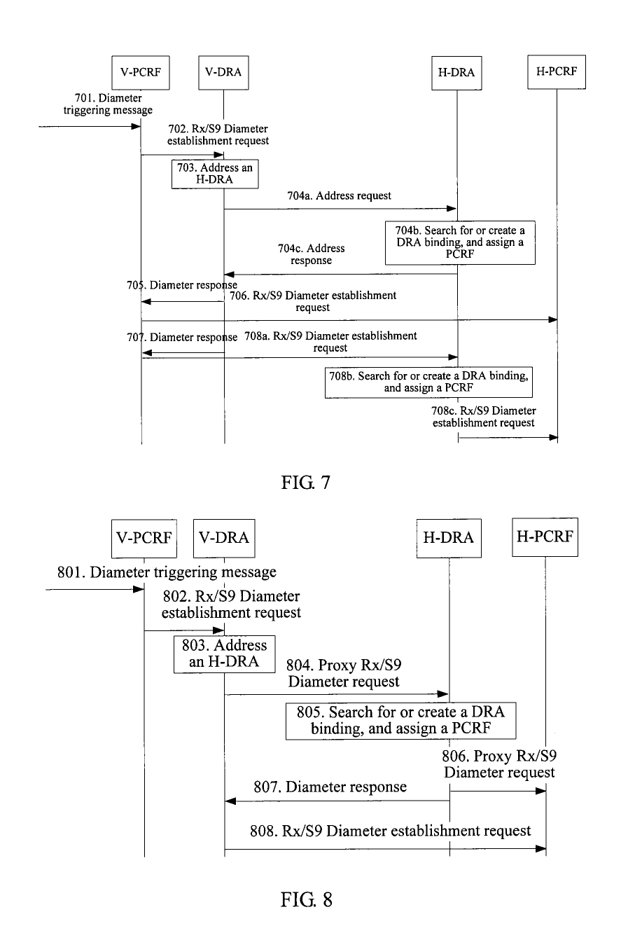

As shown in FIG. 7, a method provided in this embodiment for implementing addressing among different networks includes the following steps:

701. A policy control network element V-PCRF of the 3GPP network in the visited location receives a Diameter session triggering message (External trigger), for example, an S9 session establishment request, established to an H-PCRF.

702. The V-PCRF sends a Diameter establishment request message based on the Rx or S9 protocol to a V-DRA, where the Diameter request message carries a UE NAI mapping a terminal, including a home mobile network identity (for example, a PLMN) of the terminal.

703. The V-DRA obtains user information, for example, a UE NAI, from the received Diameter establishment request message and stores the user information; and the V-DRA selects an H-DRA of the home 3GPP network according to the home mobile network identity (for example, a PLMN) in the UE NAI and detects the functional attribute of the selected H-DRA.

Specifically, the V-DRA may select an H-DRA from the static/dynamic configuration of the device itself or DNS server according to the configuration relationship between the home mobile network identity in the NE NAI and the H-DRA.

The process of detecting the functional attribute of the selected H-DRA may be that the V-DRA actively sends a detection message to the H-DRA to obtain the functional attribute of the other party and inform the other party of its own functional attribute.

The functional attribute of the H-DRA may be the redirection function or the proxy function. If the H-DRA provides the redirection function, perform steps 704, 705, and 706; if the

H-DRA provides the proxy function, perform steps 707 and 708.

704. When the H-DRA provides the redirection function, the V-DRA obtains information about an H-PCRF of the 3GPP network from the selected H-DRA.

Specifically, step 704 may be implemented through the following procedures:

704a. The V-DRA sends a Diameter address request message to the selected H-DRA;

704b. The H-DRA stores user information (for example, a UE NAI) and checks whether an active DRA binding relationship exists; if no, the H-DRA creates a dynamic DRA binding and assigns an H-PCRF node based on each UE or each IP-CAN session;

704c. The H-DRA returns H-PCRF information to the V-DRA through a Diameter address response message. The H-PCRF information may be a Diameter Identity or an IP address of the H-PCRF.

705. The V-DRA sends the H-PCRF information to the V-PCRF through a Diameter response message.

706. The V-PCRF sends a Diameter establishment request message based on the Rx or S9 protocol to the selected H-PCRF according to the H-PCRF information.

707. When the H-DRA provides the proxy function, the V-DRA returns H-DRA information to the V-PCRF through a Diameter response message.

The H-DRA information may be a Diameter Identity or an IP address of the H-DRA.

708. The V-PCRF initiates an addressing process to the H-PCRF through the H-DRA.

Specifically, step 708 may be implemented through the following procedures:

708a. The V-PCRF sends a Diameter establishment request message based on the Rx or S9 protocol to the H-DRA according to the received H-DRA information.

708b. After receiving the Diameter establishment request message based on the Rx or S9 protocol, the H-DRA stores user information (for example, a UE NAI) and checks whether an active DRA binding relationship exists; if no, the H-DRA creates a dynamic DRA binding and assigns an H-PCRF node based on each UE or each IP-CAN session;

708c. The H-DRA forwards the Diameter establishment request message based on the Rx or S9 protocol to the selected H-PCRF.

In this embodiment, addressing between two different 3GPP networks in a roaming scenario is completed based on the Diameter routing agent network elements of the 3GPP network in the visited location and the 3GPP network in the home location of a mobile terminal; in this manner, domain isolation may be implemented between the 3GPP network in the visited location and the 3GPP network in the home location, and thereby the security of an addressing process among different networks is improved.

### Embodiment 7

A communication scenario provided in this embodiment is similar to that provided in Embodiment 6; in this embodiment, the difference is that a Diameter routing agent network element V-DRA of a 3GPP network in a visited location provides the proxy function, and a Diameter routing agent network element H-DRA of a 3GPP network in a home location provides the redirection or proxy function.

As shown in FIG. 8, a method provided in this embodiment for implementing addressing among different networks includes the following steps:

801. A policy control network element V-PCRF of the 3GPP network in the visited location receives a Diameter session triggering message, for example, an S9 session establishment request, established to an H-PCRF.

802. The V-PCRF sends a Diameter request message based on the Rx or S9 protocol to a V-DRA, where the Diameter request message carries a UE NAI, including a home mobile network identity (for example, a PLMN) of a terminal.

803. The V-DRA obtains user information, for example, a UE NAI, from the received Diameter request message and stores the user information; and the V-DRA selects an H-DRA of the 3GPP network in the home location according to the home mobile network identity (for example, a PLMN) in the UE NAI.

Specifically, the V-DRA may select an H-DRA from the static/dynamic configuration of the device itself or DNS server according to the configuration relationship between the home mobile network identity in the NE NAI and the H-DRA.

804. Because the V-DRA in this embodiment provides the proxy function, the V-DRA sends a proxy Rx/S9 Diameter request message to the selected H-DRA.

805. The H-DRA stores user information (for example, a UE NAI) and checks whether an active DRA binding relationship exists; if no, the H-DRA creates a dynamic DRA binding and assigns an H-PCRF node based on each UE or each IP-CAN session.

If the H-DRA provides the proxy function, perform step 806; if the H-DRA provides the redirection function, perform steps 807 and 808.

806. The H-DRA forwards the received proxy Rx/S9 Diameter request message to the H-PCRF.

807. The H-DRA sends a Diameter response message to the V-DRA, where the response message includes information (for example, a Diameter identity or an IP address) about the selected H-PCRF.

808. The V-DRA sends the proxy Rx/S9 Diameter request message to the H-PCRF according to the received H-PCRF information.

In this embodiment, addressing between two different 3GPP networks in a roaming scenario is completed based on the Diameter routing agent network elements of the 3GPP network in the visited location and the 3GPP network in the home location of a mobile terminal; in this manner, domain isolation may be implemented between the 3GPP network in the visited location and the 3GPP network in the home location, and thereby the security of an addressing process among different networks is improved.

### Embodiment 8

Corresponding to the preceding embodiments, this embodiment further provides a routing agent network element for implementing the preceding method.

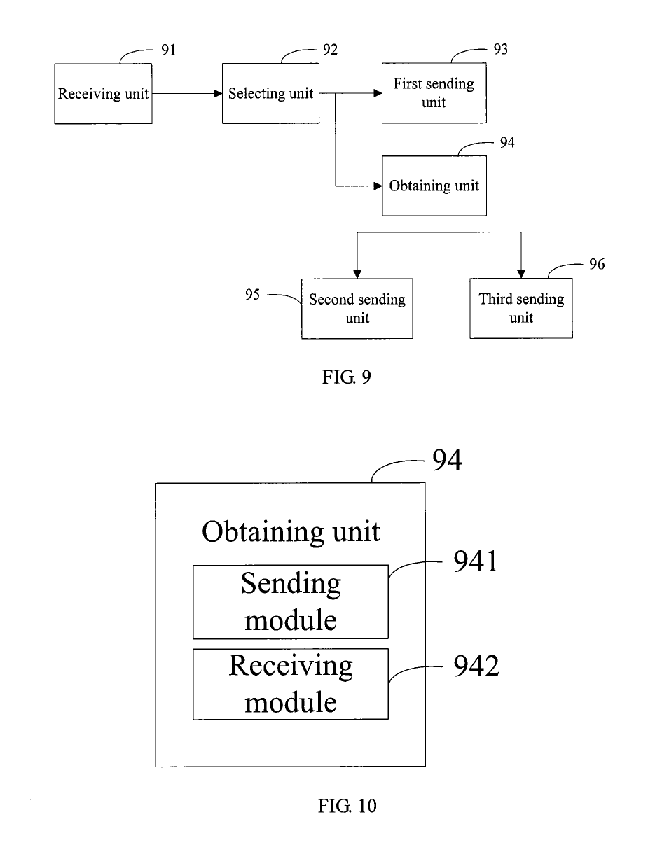

The routing agent network element provided in this embodiment is located on a first network; as shown in FIG. 9, the routing agent network element includes:

a receiving unit 91, configured to receive a Diameter request message carrying a local IP address of a terminal and/or a network identity of a second network from a policy control node of the first network;

a selecting unit 92, configured to select a routing agent network element of the second network according to the local IP address of the terminal and/or the network identity of the second network;

a first sending unit 93, configured to return network element information about the routing agent network element of the second network to the policy control node of the first network; and/or

an obtaining unit 94, configured to obtain node information about the policy control node of the second network from the routing agent network element of the second network.

Moreover, the routing agent network element in this embodiment further includes:

a second sending unit 95, configured to send node information about the policy control node of the second network obtained by the obtaining unit 94 to the policy control node of the first network, enabling the policy control node of the first network to send a message to the policy control node of the second network according to the node information; and/or

a third sending unit 96, configured to forward the Diameter request message to the policy control node of the second network according to the node information obtained by the obtaining unit 94.

As shown in FIG. 10, the obtaining unit 94 in this embodiment further includes:

a sending module 941, configured to send address request information or the Diameter request message to the routing agent network element of the second network; and

a receiving module 942, configured to receive an address response message returned by the routing agent network element of the second network, carrying node information about the policy control node of the second network selected by the routing agent network element of the second network.

For a process of implementing addressing among different networks using the preceding routing agent network element, refer to the introduction in the preceding method embodiments, and no further description is provided here.

The routing agent network element provided in this embodiment completes addressing between two networks based on routing agent network elements of the first network and the second network, may implement domain isolation between two networks, improving the security of an addressing process among different networks.

### Embodiment 9

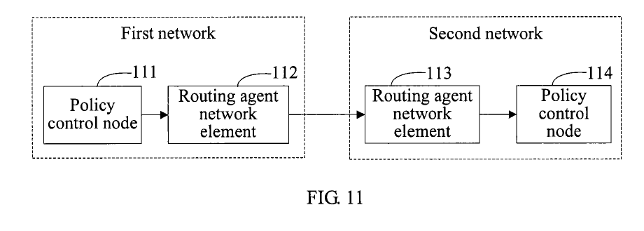

This embodiment also provides a communication system. As shown in FIG. 11, the communication system includes a policy control node 111 and a routing agent network element 112 of a first network; the communication system may further include a routing agent network element 113 and a policy control node 114 of a second network, where:

the policy control node 111 of the first network is configured to send a Diameter request message to the routing agent network element 112 of the first network, where the Diameter request message carries a local IP address of a terminal and/or a network identity of the second network;

the routing agent network element 112 of the first network is configured to select a routing agent network element 113 of the second network according to the received local IP address of the terminal and/or the network identity of the second network and return network element information about the routing agent network element 113 of the second network to the policy control node 111 of the first network; or

the routing agent network element 112 of the first network is configured to select a routing agent network element 113 of the second network according to the received local IP address of the terminal and/or the network identity of the second network and obtain node information about the policy control node of the second network from the routing agent network element 113 of the second network.

If the routing agent network element 112 of the first network provides the redirection function, the routing agent network element 112 of the first network is further configured to send the obtained node information about the policy control node of the second network to the policy control node 111 of the first network;

The policy control node 111 of the first network is further configured to send a message to the policy control node 114 of the second network according to the node information about the policy control node of the second network.

If the routing agent network element 112 of the first network provides the proxy function, the routing agent network element 112 of the first network is further configured to forward the Diameter request message to the policy control node 114 of the second network according to the obtained node information.

The communication system provided in this embodiment completes addressing between two networks based on routing agent network elements of the first network and the second network, may implement domain isolation between two networks, improving the security of an addressing process among different networks.

Through the above description of the embodiments, it is clear to persons skilled in the art that the present invention may be accomplished by software plus necessary universal hardware, and definitely may also be accomplished by hardware, but in many cases, the software implementation is preferred. Based on this, the technical solutions of the present invention or the part that makes contributions to the prior art can be substantially embodied in the form of a software product. The computer software product is stored in a readable storage medium, for example, a floppy disk, hard disk, or optical disk of the computer, and contains several instructions used to instruct computer equipment (for example, a personal computer, a server, or network equipment) to perform the methods according to the embodiments of the present invention.

The foregoing descriptions are merely exemplary embodiments of the present invention, but not intended to limit the present invention. Any variation or replacement made by persons skilled in the art without departing from the spirit of the present invention shall fall within the protection scope of the present invention. Therefore, the protection scope of the present invention shall be subject to the appended claims.

What is claimed is:

1. A method for implementing addressing among different networks, comprising:
receiving a Diameter request message carrying a local Internet Protocol (IP) address of a terminal and/or a network identity of a second network from a policy control node of a first network;
selecting a routing agent network element of the second network according to the local IP address of the terminal and/or the network identity of the second network; and
returning network element information about the routing agent network element of the second network to the policy control node of the first network; or obtaining node information about the policy control node of the second network from the routing agent network element of the second network.

2. The method according to claim 1, wherein the obtaining node information about the policy control node of the second network from the routing agent network element of the second network comprises:
sending address request information or the Diameter request message to the routing agent network element of the second network; and
receiving an address response message returned by the routing agent network element of the second network, carrying node information about the policy control node of the second network selected by the routing agent network element of the second network.

3. The method according to claim 1, wherein after the obtaining node information about the policy control node of the second network from the routing agent network element of the second network, further comprising:
sending the node information about the policy control node of the second network to the policy control node of the first network, enabling the policy control node of the first network to send a message to the policy control node of the second network according to the node information.

4. The method according to claim 1, wherein after the obtaining node information about the policy control node of the second network from the routing agent network element of the second network, further comprising:
forwarding the Diameter request message to the policy control node of the second network according to the node information.

5. The method according to claim 1, the Diameter request message is a gateway control session establishment request, or a gateway control quality of service parameter rule provisioning request message, or an Rx/S9 Diameter establishment request.

6. The method according to claim 1, the network element information about the routing agent network element of the second network comprises a Diameter identity or an IP address of the routing agent network element of the second network; and
the node information about the policy control node of the second network comprises a Diameter identity or an IP address of the policy control node of the second network.

7. The method according to claim 1, wherein the Diameter request message further carries one or multiple items of a terminal identity of the second network, a network access identifier of the second network, a terminal identity of the first network, a network access identifier of the first network, an evolved mobile packet switched domain network (EPS) IP address, and an access point name.

8. A routing agent network element, wherein the routing agent network element is located on a first network, and the routing agent network element comprises:
a receiving unit, configured to receive a Diameter request message carrying a local IP address of a terminal and/or a network identity of a second network from a policy control node of the first network; and the receiving unit is coupled to a selecting unit;
the selecting unit, configured to select a routing agent network element of the second network according to the local IP address of the terminal and/or the network identity of the second network;
and the routing agent network element further comprises at least one of the following:
a first sending unit coupled to the selecting unit, configured to return network element information about the routing agent network element of the second network to the policy control node of the first network; or
an obtaining unit coupled to the selecting unit, configured to obtain node information about the policy control node of the second network from the routing agent network element of the second network.

9. The routing agent network element according to claim 8, wherein the obtaining unit comprises:
a sending module, configured to send address request information or the Diameter request message to the routing agent network element of the second network; and
a receiving module, configured to receive an address response message returned by the routing agent network element of the second network, carrying node information about the policy control node of the second network selected by the routing agent network element of the second network.

10. The routing agent network element according to claim 8, further comprising:
a second sending unit, configured to send node information about the policy control node of the second network obtained by the obtaining unit to the policy control node of the first network, enabling the policy control node of the first network to send a message to the policy control node of the second network according to the node information.

11. The routing agent network element according to claim 8, further comprising:
a third sending unit, configured to forward the Diameter request message to the policy control node of the second network according to the node information obtained by the obtaining unit.

12. A communication system, comprising a policy control node, wherein:
the policy control node of the first network is configured to send a Diameter request message to the routing agent network element of the first network, wherein the Diameter request message carries a local IP address of a terminal and/or a network identity of a second network;
and the communication system further comprises at least one of the following:
the routing agent network element of the first network is configured to select a routing agent network element of the second network according to the received local IP address of the terminal or the network identity of the second network and return network element information about the routing agent network element of the second network to the policy control node of the first network; or
the routing agent network element of the first network is configured to select a routing agent network element of the second network according to the received local IP address of the terminal or the network identity of the second network and obtain node information about the policy control node of the second network from the routing agent network element of the second network.

13. The communication system according to claim 12, wherein:
the routing agent network element of the first network is further configured to send the obtained node information about the policy control node of the second network to the policy control node of the first network;
the policy control node of the first network is further configured to send a message to the policy control node of the second network according to the node information about the policy control node of the second network.

14. The communication system according to claim 12, wherein:
the routing agent network element of the first network is further configured to forward the Diameter request message to the policy control node of the second network according to the obtained node information.
